(19) United States
(12) Patent Application Publication
(10) Pub. No.: US 2025/0088303 A1
(43) Pub. Date: Mar. 13, 2025

(54) DISTRIBUTED RESOURCE UNITS IN A WIRELESS DOWNLINK

(71) Applicant: MAXLINEAR, INC., Carlsbad, CA (US)

(72) Inventors: Sigurd Schelstraete, Menlo Park, CA (US); Rainer Strobel, München (DE); Iñaki Val Beitia, Vitoria (ES); Marcos Martínez Vázquez, Barcelona (ES)

(73) Assignee: MAXLINEAR, INC., Carlsbad, CA (US)

(21) Appl. No.: 18/829,281

(22) Filed: Sep. 9, 2024

Related U.S. Application Data
(60) Provisional application No. 63/581,636, filed on Sep. 8, 2023.

(51) Int. Cl. H04L 1/00; H04L 5/00

(52) U.S. Cl. CPC H04L 1/0004; H04L 5/0007

(57) ABSTRACT

A system includes at least one station and a transmitter. The transmitter may be operable to transmit a transmission to the at least one station. The transmission may be associated with a bandwidth. The transmitter may adaptively select a modulation and coding scheme for the transmission. The modulation and coding scheme may allocate distributed resource units to the transmission. The distributed resource units are assigned to the at least one station and are distributed throughout the transmission.

### CROSS REFERENCE TO RELATED APPLICATIONS

This U.S. Patent Application claims priority to U.S. Provisional Patent Application No. 63/581,636, titled “DISTRIBUTED RESOURCE UNITS IN A WIRELESS DOWNLINK,” and filed on Sep. 8, 2023, the disclosure of which is hereby incorporated by reference in its entirety.

### TECHNICAL FIELD

This disclosure relates to wireless networks, and more specifically, to distributed resource units in a wireless downlink.

### BACKGROUND

Unless otherwise indicated herein, the materials described herein are not prior art to the claims in the present application and are not admitted to be prior art by inclusion in this section.

Orthogonal frequency-division multiple access (OFDMA), first defined in IEEE 802.11ax, uses allocated resource units (RUs) to allow different users to share spectrum. RUs of different sizes may be defined, but each RU may include a contiguous block of subcarriers.

Distributed RUs may include the subcarriers included in an RU and may not be contiguous, like traditional RUs. Instead, the subcarriers in the distributed RU may be spaced more or less evenly throughout the full bandwidth of the OFDMA transmission. An initial motivation for distributing the tones was to overcome regulatory power spectral density limitations in the uplink direction.

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

In an example embodiment, a system may include at least one station and a transmitter. The transmitter may be operable to transmit a transmission to the at least one station. The transmission may be associated with a bandwidth. The transmitter may adaptively select a modulation and coding scheme for the transmission. The modulation and coding scheme may allocate distributed resource units to the transmission. The distributed resource units are assigned to the at least one station and are distributed throughout the transmission.

In another embodiment, a method may include obtaining data to be transmitted to at least one station. The method may also include adaptively selecting a modulation and coding scheme for the transmission. The method may further include determining a number of tones to be used in distributed resource units. The method may also include allocating the distributed resource units to the transmission. The method may further include transmitting the transmission to the at least one station.

The objects and advantages of the embodiments will be realized and achieved at least by the elements, features, and combinations particularly pointed out in the claims.

Both the foregoing general description and the following detailed description are given as examples and are explanatory and not restrictive of the invention, as claimed.

### DESCRIPTION OF DRAWINGS

Example implementations will be described and explained with additional specificity and detail using the accompanying drawings in which:

FIG. 1 illustrates a block diagram of an example system for distributed resource units in a wireless downlink;

FIG. 2 illustrates a flowchart of an example method of distributed resource units in a wireless downlink; and

FIG. 3 illustrates an example computing device.

### DETAILED DESCRIPTION

A wireless channel (or channel) may exhibit strong frequency selectivity. The frequency response of the wireless channel may have deep nulls in one or more parts of the spectrum. In order to maximize channel throughput in the wireless channel, a transmitter (e.g., an access point, or AP) may adaptively select a modulation and coding scheme (MCS) for each transmission. The MCS may determine a number of bits modulated on each carrier and/or a coding rate of channel coding. In some instances, the same number of bits may be assigned to each of the subcarriers. Optimizing the MCS may depend on various characteristics associated with the wireless channel, including channel conditions, distance between transmitter and receiver, noise at the receiver, and/or other wireless system characteristics. When the full spectrum is used, the determined MCS may reflect the channel conditions throughout the occupied spectrum.

An RU may be a selection of subcarriers providing a certain aggregated bandwidth. In traditional RUs, some or all of the subcarriers may be contiguous (pilot tones and some RUs around direct current (DC) subcarrier may not be contiguous), such that the traditional RUs may be sensitive to the frequency selectivity of the wireless channel.

In some instances, channel conditions in a channel used for a transmission between the AP and connected stations (e.g., which may be users) may differ based on the stations and/or the frequency of the transmission. In some instances, different traditional RUs (but having the same RU size) may experience different channel conditions due to the frequency selectivity of the wireless channel, where a first RU may experience worse channel conditions (relative to a second RU) at a first location (e.g., at a first frequency) and the second RU may experience worse channel conditions (relative to the first RU) at a second location (e.g., at a second frequency).

Some traditional RUs may have a number of pilot tones disposed within the frequency boundaries of the traditional RUs. Such arrangement may include a number of disadvantages for smaller RUs. In a first example, the pilot tones may be spaced relatively closely together, meaning the pilot tones could be vulnerable to the same channel or noise conditions. In a second example, for a large number of RUs, a high total number of pilot tones may be needed. For instance, there are 37 26-tone RUs in 80 MHz. Each 26-tone RU has two pilot tones. In the extreme, this could add up to 74 pilot tones (e.g., 2 pilot tones times 37 26-tone RUs) in an 80 MHz transmission made up of 26-tone RUs. For comparison, a full-bandwidth 80 MHz transmission uses only 16 pilot tones

Aspects of the present disclosure address these and other limitations by using distributed RUs in a transmission from the AP to a station. A distributed RU may include the same number of subcarriers as the traditional RU, but the subcarriers in the distributed RU may be spread throughout the bandwidth. For a distributed RU, the tones may be effectively spread across the whole spectrum, which may provide a sampling of the channel response across the whole spectrum. For instance, the tones for several potential distributed RUs may be allocated uniformly across the whole spectrum.

In these and other embodiments, the observed channel conditions when using distributed RUs may be the same or similar as an original channel (e.g., the channel without distributed RUs), such that the observed channel conditions are the same or similar to the channel conditions experienced by a single user (SU) transmission. As such, rate adaptation in a system using distributed RUs may be performed independently of the location of the RU and/or independently of the size of the RU. The same rate adaptation could also be used for SU and orthogonal frequency-division multiple access (OFDMA). In some instances, all transmission modes may use the same MCS, so training may be performed regardless of which mode of operation is used. Using such a configuration may eliminate separate rate adaptations for potentially each RU location, facilitate a single rate adaptation training being used, and/or an MCS value for a given RU may not become “out of date” due to a lack of use of the given RU over a period of time.

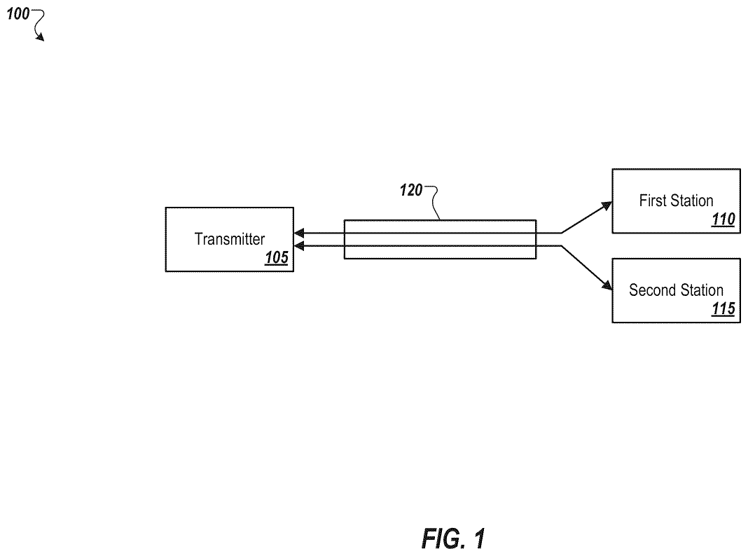

FIG. 1 illustrates a block diagram of an example system 100 for distributed resource units in a wireless downlink, in accordance with at least one embodiment of the present disclosure. The system 100 may include a transmitter 105, a first station 110, a second station 115, and a channel 120.

In instances in which orthogonal frequency-division multiple access (OFDMA) is used by the transmitter 105, the MCS may be indicated separately for each resource unit (RU). For each of the RUs, the MCS may be chosen to reflect channel conditions of the channel 120 within that RU. Given the variability in the frequency response, an optimal MCS for each individual RU could be significantly different. For example, the MCS for a first RU may be different from the MCS used in other RUs and/or may be different from the MCS that is used in a single user (SU) transmission occupying the full spectrum.

As such, each RU may use its own rate adaptation. Rate adaptation may include a process of determining an optimal MCS for a particular transmission. Rate adaptation may include tracking certain metrics (e.g., packet error rates based on received acknowledgements, signal-to-noise ratio (SNR) feedback from the first station 110, and/or other metrics) and/or sampling different MCSs to converge to the optimal MCS for the particular transmission.

Flexible allocation of RUs may be beneficial to different stations or users (e.g., the first station 110 and/or the second station 115) based on a need by the individual stations. For example, different stations may use a varying RU from one another and/or the same station may use a different number of RUs at different times. The assignment of RUs to a particular station (e.g., the first station 110) may depend on a number of factors, such as other stations (e.g., the second station 115) the first station 110 may be paired with in the OFDMA transmission, bandwidth that may be used by the second station 115 (e.g., allowing more or less bandwidth (BW) for the first station 110), whether data for the first station 110 may be sent in OFDMA or SU, and/or other factors.

Flexibility in the system 100 including the transmitter 105 (e.g., an AP) and at least one station (e.g., the first station 110 and/or the second station 115) may be possible when the transmitter 105 may have established a suitable MCS for each of the possible resource allocations of the first station 110. For instance, the transmitter 105 may alternate between transmitting SU packets to the first station 110, transmitting OFDMA packets where only one other user (e.g., the second station 115) is involved where both the first station 110 and the second station 115 may be allocated half of the total BW, transmitting OFDMA packets where multiple other stations (e.g., at least a third station (not illustrated)) are involved where the first station 110 may be allocated a fraction of the total BW, and/or modify the location of the RU in the transmission depending on the other stations in the OFDMA packet (e.g., even when the RU size for the first station 110 is the same RU size as may have previously been used).

Each of the described transmissions may potentially use their own MCS and an accompanying rate adaptation instance such that the selected MCS may be optimal and/or the selected MCS stays up to date. Rate adaptation training may utilize a regular availability of packets, so having to train multiple MCS would mean that the transmitter 105 may be caused to use each of the modes regularly, even if channel conditions of the channel 120 and/or traffic conditions may not call for some of the modes to be used.

In some instances, the frequency selectivity of the channel 120 could be used to optimize performance by assigning a “best” RU to each station. However, some issues with assigning the best RU to each station may include knowing the best RU may utilize knowledge of an optimal MCS for each RU which may imply an advanced rate adaptation algorithm, and/or the same RU may be optimal for different stations which may mean that compromises may be made between a best RU for any given station and/or that knowing the MCS in just one RU may be insufficient to determining an RU for another station—which may again point to an advanced rate adaptation algorithm.

Regarding the pilot tones, for distributed RUs, each receiver (e.g., stations, or the first station 110 and/or the second station 115) may select tones from the full bandwidth. As such, a single set of pilot tones may be defined (e.g., 16 tones for 80 MHz) that can be used by some or all of the distributed RUs. The single set of pilot tones may reduce the overall number of pilot tones and/or may increase efficiency in the system 100. Alternatively, or additionally, the single set of pilot tones may make the processing of pilot tones independent of the specific RU, the location of the RU, and/or the bandwidth of the RU.

In determining the number of tones for various levels of the RU hierarchy, consideration may be made in view of the compatibility between the tones, the ease of combining RUs of different sizes, allowance for blind convolutional code (BCC) coding for small RUs (where small RUs may be less than the equivalent of a 242-tone RU), and/or maximizing the number of tones in an RU. The allowance for blind convolutional code (BCC) coding for small RUs may define that the number of tones be divisible by 6 to accommodate a 5/6 code rate with BCC. The example given in Table 1 stays close to the sizes that are currently used for traditional RUs.

TABLE 1
Possible Distributed RU Sizes

| | |
|---|---|
| | Possible |
| | distributed |
| Traditional | RUs (dRUs) |

| Ru | #data | #RU in | #data | #dRU in |
|---|---|---|---|---|
| size | tones | 80 MHz | tones | 80 MHz |
| 26 | 24 | 37 | 30 | 32 |
| 52 | 50 | 16 | 60 | 16 |
| 106 | 102 | 8 | 120 | 8 |
| 242 | 234 | 4 | 240 | 4 |
| 484 | 468 | 2 | 490 | 2 |
| 996 | 980 | 1 | 980 | 1 |

The RU sizes (specifically, the number of data tones) of the distributed RUs may differ from the traditional RUs, as illustrated in Table 1, but there may be a one-to-one correspondence. For example, for each traditional RU, there may be a distributed RU of similar size. The number of distributed RUs may be chosen to allow for a simple selection of the tones. There are 980 data tones in 80 MHz, namely, [−500:−3, 3:500] and {-468,−400,−334,−266,−226,−158,−92,−24, 24, 92, 158, 226, 266, 334, 400, 468}. In the remainder, the tone indices may not be referred to directly, but rather as indices 0 to 979. Each value between 0 and 979 (e.g., the indices) may directly map to one of the data tones included in the 980 data tones in 80 MHz.

Further, the same number of data tones and pilot tones in the 80 MHz distributed RU may be maintained as for the 80 MHz traditional RU. In this case, the traditional RUs and the distributed RUs may be identical. Where there is only one such distributed RU in 80 MHz, it may be denoted as RU₉₈₀⁽¹⁾. For distributed RUs of a lower size, the starting set of tones (e.g., the 980 data tones in 80 MHz listed above) may be split into 2, 4, 8, etc. groups, with each group having the same number of tones. For instance, an RU using half of the tones can be obtained by taking either the even tones or the odd tones of RU₉₈₀⁽¹⁾. This results in two RUs with 490 data tones (RU₄₉₀⁽¹⁾ and RU₄₉₀⁽²⁾).

Each RU₄₉₀⁽ⁱ⁾ may further be split into two, again by taking even tones and odd tones of each. Such a split would produce four RUs with 245 data tones. However, RUs having 245 data tones may experience issues. For example, the 245 data tones may not be further divisible by 2. Alternatively, or additionally, for RUs where BCC coding is used, the number of data tones should be a multiple of 6 to support code rate 5/6. Note, that this may be used for low density parity check (LDPC), where N_{CBPS} and N_{DBPS} may not have an exact relationship (e.g., where rounding may be allowed). However, the number 245 is not divisible by six. In high efficiency (HE) and extremely high throughput (EHT), LDPC may be used for most transmissions, but BCC may be maintained as a possible coding scheme for RUs of 20 MHz (242 tones) and below. As such, it may be beneficial to keep the same for distributed RUs of lower sizes. For at least the above reasons, the next division of RUs (e.g., below RU₄₉₀⁽ⁱ⁾) may be 240 data tones each. As such, a total of 20 tones may be removed at this stage. A discussion relative to selecting which 20 tones is described herein.

Once the 240 tones of each of the four RU₂₄₀⁽ⁱ⁾ are identified, the division can proceed by taking even tones and odd tones of each RU₂₄₀⁽ⁱ⁾ to obtain eight RU₁₂₀⁽ⁱ⁾. Each of the RU₁₂₀⁽ⁱ⁾ can further be divided into even tones and odd tones to obtain 16 RURU₆₀⁽ⁱ⁾. Further still, each of the RU₆₀⁽ⁱ⁾ can be divided into even tones and odd tones produce 32 RU₃₀⁽ⁱ⁾.

Using the above approach (e.g., splitting the tones), the set of tones making up RU_{N}_{_{SD}}⁽ⁱ⁾ may be represented simply as: (i−1): 2:979 for N_{SD}=490, (i−1): 4:979 for N_{SD}=240, (i−1): 8:979 for N_{SD}=120, (i−1): 16:979 for N_{SD}=60, and (i−1): 32:979 for N_{SD}=30. Table 2 shows the size of each of these RU_{N}_{_{SD}}⁽ⁱ⁾ without modification.

TABLE 2
Initial Size of the Distributed RU (dRU) Tone Sets

| dRU Size | | Number |
|---|---|---|
| and Index | Indices | of tones |
| RU₉₈₀⁽¹⁾ | 0:979 | 980 |
| RU₄₉₀⁽¹⁾ | 0:2:979 | 490 |
| RU₄₉₀⁽²⁾ | 1:2:979 | 490 |
| RU₂₄₀⁽¹⁾ | 0:4:979 | 245 |
| RU₂₄₀⁽²⁾ | 1:4:979 | 245 |
| RU₂₄₀⁽³⁾ | 2:4:979 | 245 |
| RU₂₄₀⁽⁴⁾ | 3:4:979 | 245 |
| RU₁₂₀⁽¹⁾ | 0:8:979 | 123 |
| RU₁₂₀⁽²⁾ | 1:8:979 | 123 |
| RU₁₂₀⁽³⁾ | 2:8:979 | 123 |
| RU₁₂₀⁽⁴⁾ | 3:8:979 | 123 |
| RU₁₂₀⁽⁵⁾ | 4:8:979 | 122 |
| RU₁₂₀⁽⁶⁾ | 5:8:979 | 122 |
| RU₁₂₀⁽⁷⁾ | 6:8:979 | 122 |
| RU₁₂₀⁽⁸⁾ | 7:8:979 | 122 |
| RU₆₀⁽¹⁾ | 0:16:979 | 62 |
| RU₆₀⁽²⁾ | 1:16:979 | 62 |
| RU₆₀⁽³⁾ | 2:16:979 | 62 |
| RU₆₀⁽⁴⁾ | 3:16:979 | 62 |
| RU₆₀⁽⁵⁾ | 4:16:979 | 61 |
| RU₆₀⁽⁶⁾ | 5:16:979 | 61 |
| RU₆₀⁽⁷⁾ | 6:16:979 | 61 |
| RU₆₀⁽⁸⁾ | 7:16:979 | 61 |
| RU₆₀⁽⁹⁾ | 8:16:979 | 61 |
| RU₆₀⁽¹⁰⁾ | 9:16:979 | 61 |
| RU₆₀⁽¹¹⁾ | 10:16:979 | 61 |
| RU₆₀⁽¹²⁾ | 11:16:979 | 61 |
| RU₆₀⁽¹³⁾ | 12:16:979 | 61 |
| RU₆₀⁽¹⁴⁾ | 13:16:979 | 61 |
| RU₆₀⁽¹⁵⁾ | 14:16:979 | 61 |
| RU₆₀⁽¹⁶⁾ | 15:16:979 | 61 |
| RU₃₀⁽¹⁾ | 0:32:979 | 31 |
| RU₃₀⁽²⁾ | 1:32:979 | 31 |
| RU₃₀⁽³⁾ | 2:32:979 | 31 |
| RU₃₀⁽⁴⁾ | 3:32:979 | 31 |
| RU₃₀⁽⁵⁾ | 4:32:979 | 31 |
| RU₃₀⁽⁶⁾ | 5:32:979 | 31 |
| RU₃₀⁽⁷⁾ | 6:32:979 | 31 |
| RU₃₀⁽⁸⁾ | 7:32:979 | 31 |
| RU₃₀⁽⁹⁾ | 8:32:979 | 31 |
| RU₃₀⁽¹⁰⁾ | 9:32:979 | 31 |
| RU₃₀⁽¹¹⁾ | 10:32:979 | 31 |
| RU₃₀⁽¹²⁾ | 11:32:979 | 31 |
| RU₃₀⁽¹³⁾ | 12:32:979 | 31 |
| RU₃₀⁽¹⁴⁾ | 13:32:979 | 31 |
| RU₃₀⁽¹⁵⁾ | 14:32:979 | 31 |
| RU₃₀⁽¹⁶⁾ | 15:32:979 | 31 |
| RU₃₀⁽¹⁷⁾ | 16:32:979 | 31 |
| RU₃₀⁽¹⁸⁾ | 17:32:979 | 31 |
| RU₃₀⁽¹⁹⁾ | 18:32:979 | 31 |
| RU₃₀⁽²⁰⁾ | 19:32:979 | 31 |
| RU₃₀⁽²¹⁾ | 20:32:979 | 30 |
| RU₃₀⁽²²⁾ | 21:32:979 | 30 |
| RU₃₀⁽²³⁾ | 22:32:979 | 30 |
| RU₃₀⁽²⁴⁾ | 23:32:979 | 30 |
| RU₃₀⁽²⁵⁾ | 24:32:979 | 30 |
| RU₃₀⁽²⁶⁾ | 25:32:979 | 30 |
| RU₃₀⁽²⁷⁾ | 26:32:979 | 30 |
| RU₃₀⁽²⁸⁾ | 27:32:979 | 30 |
| RU₃₀⁽²⁹⁾ | 28:32:979 | 30 |
| RU₃₀⁽³⁰⁾ | 29:32:979 | 30 |
| RU₃₀⁽³¹⁾ | 30:32:979 | 30 |
| RU₃₀⁽³²⁾ | 31:32:979 | 30 |

From Table 2, it can be observed that a straightforward allocation of indices based on a tone separation equal to powers of two may lead to some of the RUs having more than the desired number of tones. Moreover, in some instances, not all RUs even have the same number of data tones (e.g., for N_{SD}=60, the actual number of tones could be 62 or 61).

For RU sizes less than or equal to 240 data tones, a total of 20 tones still needs to be removed, as described herein. The 20 tones to be removed may be removed selectively. As such, all RUs with excess tones (underlined in Table 2) may have the desired number of tones. For example, one possible choice for the 20 tones to be removed may be S₂₀={0, 1, . . . , 9, 970, 971, . . . , 979}.

The notation S₂₀ denotes the set of 20 tones that should be skipped. As such, the final tone allocation for each distributed RU RU_{BW}⁽ⁱ⁾ may then be represented by RU_{BW}⁽ⁱ⁾→RU_{BW}⁽ⁱ⁾ \S₂₀. It can be verified that the distributed RUs generated using the S₂₀ described above and RU_{BW}⁽ⁱ⁾→RU_{BW}⁽ⁱ⁾ \S₂₀ may have the desired number of tones (240, 120, 60, and 30, respectively).

While S₂₀ given above may be sufficient, S₂₀ may have a drawback that the skipped tones may be concentrated together at either the start or the end of the data tones, such as the 980 data tones in 80 MHz provided herein. There are many possible alternatives to generate S₂₀, and in some circumstances, it may be beneficial to spread the skipped tones more evenly among the tones. Although a perfectly even spread may not be possible, S₂₀=x: 49:979 would produce 20 tones that may be evenly spread for any 0≤x≤49. However, the previous set would not produce the right sizes for all distributed RUs. For example, for x=0, RU₃₀⁽⁶⁾ \S₂₀ would have 31 tones, while RU₃₀⁽²⁴⁾ \S₂₀ would have 29 tones.

In some instances, a family of possible skipped indices S₂₀ that may spread the skipped tones more evenly may be obtained using the following two steps. First, a set of 20 numbers (I₂₀) may be generated between 0 and 30. Further, all numbers of the form 3m may be removed from the set I₂₀. Alternatively, or additionally, all numbers of the form 3m+1 or of the form 3m+2 may be removed. In instances in which the results of the first step includes 21 or more numbers, remove the first or the last number therein. Second, pick any random permutation of the number 0 to 19 (P₂₀). In some instances, a convenient subset of all permutations would be a cyclic shift using N, . . . , 19, 0, . . . , N−1]=mod(N+k, 20), k=0, . . . , 19.

For any given I₂₀ and P₂₀, the following sets of skipped indices S₂₀ may produce RUs of the desired size:

$${S}_{20} ( k ) = 32 \times {I}_{20} ( k ) + {P}_{20} ( k )$$

$$k = 0 , … , 19$$

For example, 0:30 with all number of the form 3m+1 removed may result in the set [0 2 3 5 6 8 9 11 12 14 15 17 18 20 21 23 24 26 27 29 30]. However, the above set includes 21 numbers. The first or last element may be removed to obtain a set of 20. For example, I₂₀=[2 3 5 6 8 9 11 12 14 15 17 18 20 21 23 24 26 27 29 30], where the 0 value has been removed.

Taking a cyclic shift for P₂₀ with N equal to 11 (e.g., provide as an example), the following set may be obtained mod(N+k, 20)=[11 12 13 14 15 16 17 18 19 0 1 2 3 4 5 6 7 8 9 10]. Using the above cyclic shift, the skipped tones S₂₀ may be S₂₀=[75 108 173 206 271 304 369 402 467 480 545 578 643 676 741 774 839 872 937 970]. It can be verified that x: 32:979 S₂₀ has 30 elements for all values of x between 0 and 31. As such, each of the RU₃₀ may include 30 tones. Similarly, R₆₀⁽ⁱ⁾, R₁₂₀⁽ⁱ⁾, and R₂₄₀⁽ⁱ⁾ may have the desired number of tones.

While the set S₂₀ shown above meets the criteria of 20 skipped tones that are more evenly distributed, the indices are not symmetric (e.g., the first index is 75 above the lowest index (0), the last is 27 below the highest index (979)). By adjusting the selection of I₂₀ and N for P₂₀, the final set S₂₀ may be tuned to become more symmetric. For example,

$${I}_{20} = [ \begin{matrix}1 & 2 & 4 & 5 & 7 & 8 & 10 & 11 & 13 & 14 & 16 & 17 & 19 & 20 & 22 & 23 & 25 & 26 & 28 & 29\end{matrix} ]$$

$$N = 10 \to {P}_{20} = mod ( N + K , 20 ) = [ \begin{matrix}10 & 11 & 12 & 13 & 14 & 15 & 16 & 17 & 18 & 19 & 0 & 1 & 2 & 3 & 4 & 5 & 6 & 7 & 8 & 9 ]\end{matrix}$$

$${S}_{20} = [ \begin{matrix}75 & 108 & 173 & 206 & 271 & 304 & 369 & 402 & 467 & 480 & 545 & 578 & 643 & 741 & 774 & 839 & 872 & 937 & 970 ]\end{matrix}$$

Using the above example, the first index may be 42 above the lowest index (0) and the last one is 42 below the highest index (979). Table 3 lists the final set of tones for each of the R₃₀⁽ⁱ⁾. The underlined indices show where an intermediate tone has been removed.

TABLE 3
Indices when S₂₀ = [75 108 173 206 271 304 369 402
467 480 545 578 643 676 741 774 839 872 937 970]

| | |
|---|---|
| RU₃₀⁽¹⁾ | 0, 32, 64, 96, 128, 160, 192, 224, 256, 288, 320, 352, 384, 416, 448, 480, |
| | 544, 576, 608, 640, 672, 704, 736, 768, 800, 832, 864, 896, 928, 960 |
| RU₃₀⁽²⁾ | 1, 33, 65, 97, 129, 161, 193, 225, 257, 289, 321, 353, 385, 417, 449, 481, |
| | 513, 577, 609, 641, 673, 705, 737, 769, 801, 833, 865, 897, 929, 961 |
| RU₃₀⁽³⁾ | 2, 34, 66, 98, 130, 162, 194, 226, 258, 290, 322, 354, 386, 418, 450, 482, |
| | 514, 546, 578, 642, 674, 706, 738, 770, 802, 834, 866, 898, 930, 962 |
| RU₃₀⁽⁴⁾ | 3, 35, 67, 99, 131, 163, 195, 227, 259, 291, 323, 355, 387, 419, 451, 483, |
| | 515, 547, 579, 611, 675, 707, 739, 771, 803, 835, 867, 899, 931, 963 |
| RU₃₀⁽⁵⁾ | 4, 36, 68, 100, 132, 164, 196, 228, 260, 292, 324, 356, 388, 420, 452, 484, |
| | 516, 548, 580, 612, 644, 676, 740, 772, 804, 836, 868, 900, 932, 964 |
| RU₃₀⁽⁶⁾ | 5, 37, 69, 101, 133, 165, 197, 229, 261, 293, 325, 357, 389, 421, 453, 485, |
| | 517, 549, 581, 613, 645, 677, 709, 773, 805, 837, 869, 901, 933, 965 |
| RU₃₀⁽⁷⁾ | 6, 38, 70, 102, 134, 166, 198, 230, 262, 294, 326, 358, 390, 422, 454, 486, |
| | 518, 550, 582, 614, 646, 678, 710, 742, 774, 838, 870, 902, 934, 966 |
| RU₃₀⁽⁸⁾ | 7, 39, 71, 103, 135, 167, 199, 231, 263, 295, 327, 359, 391, 423, 455, 487, |
| | 519, 551, 583, 615, 647, 679, 711, 743, 775, 807, 871, 903, 935, 967 |
| RU₃₀⁽⁹⁾ | 8, 40, 72, 104, 136, 168, 200, 232, 264, 296, 328, 360, 392, 424, 456, 488, |
| | 520, 552, 584, 616, 648, 680, 712, 744, 776, 808, 840, 872, 936, 968 |
| RU₃₀⁽¹⁰⁾ | 9, 41, 73, 105, 137, 169, 201, 233, 265, 297, 329, 361, 393, 425, 457, 489, |
| | 521, 553, 585, 617, 649, 681, 713, 745, 777, 809, 841, 873, 905, 969 |
| RU₃₀⁽¹¹⁾ | 10, 74, 106, 138, 170, 202, 234, 266, 298, 330, 362, 394, 426, 458, 490, |
| | 522, 554, 586, 618, 650, 682, 714, 746, 778, 810, 842, 874, 906, 938, 970 |
| RU₃₀⁽¹²⁾ | 11, 43, 107, 139, 171, 203, 235, 267, 299, 331, 363, 395, 427, 459, 491, |
| | 523, 555, 587, 619, 651, 683, 715, 747, 779, 811, 843, 875, 907, 939, 97 |
| RU₃₀⁽¹³⁾ | 12, 44, 76, 108, 172, 204, 236, 268, 300, 332, 364, 396, 428, 460, 492, |
| | 524, 556, 588, 620, 652, 684, 716, 748, 780, 812, 844, 876, 908, 940, 972 |
| RU₃₀⁽¹⁴⁾ | 13, 45, 77, 109, 141, 205, 237, 269, 301, 333, 365, 397, 429, 461, 493, |
| | 525, 557, 589, 621, 653, 685, 717, 749, 781, 813, 845, 877, 909, 941, 973 |
| RU₃₀⁽¹⁵⁾ | 14, 46, 78, 110, 142, 174, 206, 270, 302, 334, 366, 398, 430, 462, 494, |
| | 526, 558, 590, 622, 654, 686, 718, 750, 782, 814, 846, 878, 910, 942, 974 |
| RU₃₀⁽¹⁶⁾ | 15, 47, 79, 111, 143, 175, 207, 239, 303, 335, 367, 399, 431, 463, 495, |
| | 527, 559, 591, 623, 655, 687, 719, 751, 783, 815, 847, 879, 911, 943, 975 |
| RU₃₀⁽¹⁷⁾ | 16, 48, 80, 112, 144, 176, 208, 240, 272, 304, 368, 400, 432, 464, 496, |
| | 528, 560, 592, 624, 656, 688, 720, 752, 784, 816, 848, 880, 912, 944, 976 |
| RU₃₀⁽¹⁸⁾ | 17, 49, 81, 113, 145, 177, 209, 241, 273, 305, 337, 401, 433, 465, 497, |
| | 529, 561, 593, 625, 657, 689, 721, 753, 785, 817, 849, 881, 913, 945, 977 |
| RU₃₀⁽¹⁹⁾ | 18, 50, 82, 114, 146, 178, 210, 242, 274, 306, 338, 370, 402, 466, 498, |
| | 530, 562, 594, 626, 658, 690, 722, 754, 786, 818, 850, 882, 914, 946, 978 |
| RU₃₀⁽²⁰⁾ | 19, 51, 83, 115, 147, 179, 211, 243, 275, 307, 339, 371, 403, 435, 499, |
| | 531, 563, 595, 627, 659, 691, 723, 755, 787, 819, 851, 883, 915, 947, 979 |
| RU₃₀⁽²¹⁾ | 20, 52, 84, 116, 148, 180, 212, 244, 276, 308, 340, 372, 404, 436, 468, |
| | 500, 532, 564, 596, 628, 660, 692, 724, 756, 788, 820, 852, 884, 916, 948 |
| RU₃₀⁽²²⁾ | 21, 53, 85, 117, 149, 181, 213, 245, 277, 309, 341, 373, 405, 437, 469, |
| | 501, 533, 565, 597, 629, 661, 693, 725, 757, 789, 821, 853, 885, 917, 949 |
| RU₃₀⁽²³⁾ | 22, 54, 86, 118, 150, 182, 214, 246, 278, 310, 342, 374, 406, 438, 470, |
| | 502, 534, 566, 598, 630, 662, 694, 726, 758, 790, 822, 854, 886, 918, 950 |
| RU₃₀⁽²⁴⁾ | 23, 55, 87, 119, 151, 183, 215, 247, 279, 311, 343, 375, 407, 439, 471, |
| | 503, 535, 567, 599, 631, 663, 695, 727, 759, 791, 823, 855, 887, 919, 951 |
| RU₃₀⁽²⁵⁾ | 24, 56, 88, 120, 152, 184, 216, 248, 280, 312, 344, 376, 408, 440, 472, |
| | 504, 536, 568, 600, 632, 664, 696, 728, 760, 792, 824, 856, 888, 920, 952 |
| RU₃₀⁽²⁶⁾ | 25, 57, 89, 121, 153, 185, 217, 249, 281, 313, 345, 377, 409, 441, 473, |
| | 505, 537, 569, 601, 633, 665, 697, 729, 761, 793, 825, 857, 889, 921, 953 |
| RU₃₀⁽²⁷⁾ | 26, 58, 90, 122, 154, 186, 218, 250, 282, 314, 346, 378, 410, 442, 474, |
| | 506, 538, 570, 602, 634, 666, 698, 730, 762, 794, 826, 858, 890, 922, 954 |
| RU₃₀⁽²⁸⁾ | 27, 59, 91, 123, 155, 187, 219, 251, 283, 315, 347, 379, 411, 443, 475, |
| | 507, 539, 571, 603, 635, 667, 699, 731, 763, 795, 827, 859, 891, 923, 955 |
| RU₃₀⁽²⁹⁾ | 28, 60, 92, 124, 156, 188, 220, 252, 284, 316, 348, 380, 412, 444, 476, |
| | 508, 540, 572, 604, 636, 668, 700, 732, 764, 796, 828, 860, 892, 924, 956 |
| RU₃₀⁽³⁰⁾ | 29, 61, 93, 125, 157, 189, 221, 253, 285, 317, 349, 381, 413, 445, 477, |
| | 509, 541, 573, 605, 637, 669, 701, 733, 765, 797, 829, 861, 893, 925, 957 |
| RU₃₀⁽³¹⁾ | 30, 62, 94, 126, 158, 190, 222, 254, 286, 318, 350, 382, 414, 446, 478, |
| | 510, 542, 574, 606, 638, 670, 702, 734, 766, 798, 830, 862, 894, 926, 958 |
| RU₃₀⁽³²⁾ | 31, 63, 95, 127, 159, 191, 223, 255, 287, 319, 351, 383, 415, 447, 479, |
| | 511, 543, 575, 607, 639, 671, 703, 735, 767, 799, 831, 863, 895, 927, 959 |

As illustrated in Table 3, RU₃₀⁽²¹⁾ to RU₃₀⁽³²⁾ are not affected by S₂₀. Those RUs already have 30 tones, so no reduction may be implemented. Once all RU₃₀⁽ⁱ⁾ are defined, the construction logic for higher distributed RUs may include:

$${RU}_{60}^{( i )} = {RU}_{30}^{( i )} + {RU}_{30}^{( i + 16 )} , i = 1 , … , 16$$

$${RU}_{120}^{( i )} = {RU}_{60}^{( i )} + {RU}_{60}^{( i + 8 )} , i = 1 , … , 8 = {RU}_{30}^{( i )} + {RU}_{30}^{( i + 8 )} + {RU}_{30}^{( i + 16 )} + {RU}_{30}^{( i + 24 )}$$

$${RU}_{240}^{( i )} = {RU}_{120}^{( i )} + {RU}_{120}^{( i + 4 )} , i = 1 , … , 4 = {RU}_{30}^{( i )} + {RU}_{30}^{( i + 4 )} + {RU}_{30}^{( i + 8 )} + {RU}_{30}^{( i + 12 )} + {RU}_{30}^{( i + 16 )} +$$

$${RU}_{30}^{( i + 20 )} + {RU}_{30}^{( i + 24 )} + {RU}_{30}^{( i + 28 )} {RU}_{490}^{( 1 )} = {RU}_{240}^{( 1 )} + {RU}_{240}^{( 3 )} + even tones in {S}_{20}$$

$${RU}_{490}^{( 2 )} = {RU}_{240}^{( 2 )} + {RU}_{240}^{( 4 )} + odd tones in {S}_{20}$$

$${RU}_{980}^{( 1 )} = {RU}_{490}^{( 1 )} + {RU}_{490}^{( 2 )}$$

The analysis above with respect to the tones may be done starting from 80 MHz, because this bandwidth is commonly supported by all EHT devices (with the exception of 20 MHz-only devices). However, larger bandwidths (e.g., 160 MHz, 320 MHz) may also be utilized. As such, two approaches for distributing RUs for those bandwidths may be used. In a first approach, the design flow given above may be repeated, starting with a larger bandwidth and splitting up the spectrum (160 or 320 MHz) into smaller sets down until the smallest desired distributed RU. In a second approach, the distributed RUs may be defined per 80 MHz and the design above may be replicated in each 80 MHz falling within the full bandwidth.

The first approach may produce a set of distributed RUs and may preserve the sampling property of each RU. For example, the rate adaptation could be run with any distributed RU size. However, the distributed RUs may be incompatible with 80 MHz operation. For instance, an 80 MHz distributed RU in a 160 MHz bandwidth may occupy the even tones and therefore would only have 40 MHz worth of bandwidth in each 80 MHz.

The second approach may be compatible with 80 MHz operation. However, the rate adaptation may be more involved. For example, the rate adaptation may track an MCS in both the upper and lower 80 MHz of a 160 MHz transmission. However, such an approach may be an improvement over the situation with traditional RUs.

A distributed 80 MHz distributed RU in a 160 MHz bandwidth may not necessarily be incompatible with 80 MHz operation. For instance, an 80 MHz distributed RU on the even tones may be combined with a distributed 40 MHz RU in the lower 80 MHz and a distributed 40 MHz RU in the upper 80 MHz, both distributed 40 MHz located on the odd tones.

Referring back to determining the tone set to skip (e.g., S₂₀), starting from the a priori tone allocations of RU₃₀⁽ⁱ⁾, it can be observed that (i−1): 32:979 for i=1, . . . , 32 divides the indices 0 to 979 in 32 groups. Additionally, 980 itself can be written as 30×32+20 (e.g., 30 groups, 32 tones per group, and 20 additional tones). The 980 tones may include 30 groups of 32 tones and one additional block of 20 tones at the end. Each tone set (i−1): 32:979 may take one tone from each of the blocks of 32 tones. In some instances, the first 20 tone sets (with offset 0 to 19) may result in 31 tones being selected because of the presence of the extra 20-tone block at the end. The remaining 12 tone sets may have 30 tones.

As such, each tone set may be reduced to 30 tones by skipping all tones in any of the blocks of 20 tones (e.g., there may be 31 such blocks). For example, picking the last block may work, but would result in a set S₂₀ whose tones may not be evenly and/or symmetrically spread throughout the spectrum.

Another solution may include dropping one tone each in 20 (out of 31) of the blocks of 20 tones. In such instances, determining which of the 20 blocks of the 31 blocks may be accomplished by dropping every third number. Hence removing indices of the form 3m (or 3m+1, or 3m+2) plus possibly one extra number may provide the set of 20 blocks of 20 tones. Next may be to ensure that the removed tones in each of these blocks belong to different sets (i−1): 32:979. Stated another way, ensure that the removed tones in each of the block belong to a different offset. Picking the first tone in the first 20-tone block, the second tone in the second 20-tone block, and so forth, may achieve removing tones from the blocks that belong to different sets. Alternatively, or additionally, any permutation of the numbers 0 to 19 would work, since these all pick one unique offset per block.

In some instances, the selection of the tones in S₂₀ may be described by I₂₀ being the indices of the selected 20-tone blocks (taking values between 0 and 30), 32×I₂₀ may provide the starting indices of each of those 20-tone blocks, P₂₀ may be a set of unique tone offsets, and 32×I₂₀(k)+P₂₀(k) may select tones at offset P₂₀(k) in the 20-tone block I₂₀(k). The result for S₂₀ using the above determination may result in 20 tones, with each tone belonging to a unique RU₃.

Modifications, additions, or omissions may be made to the system 100 without departing from the scope of the present disclosure. For example, the designations of different elements in the manner described is meant to help explain concepts described herein and is not limiting. Further, the system 100 may include any number of other elements or may be implemented within other systems or contexts than those described. For example, any of the components of FIG. 1 may be divided into additional or combined into fewer components.

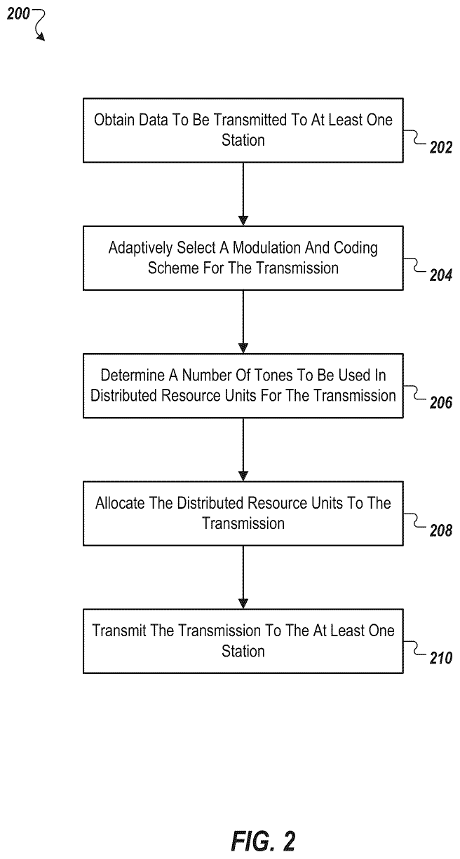

FIG. 2 illustrates a flowchart of an example method 200 of distributed resource units in a wireless downlink, in accordance with at least one embodiment of the present disclosure. At block 202, data to be transmitted to at least one station may be obtained.

At block 204, a modulation and coding scheme may be adaptively selected for the transmission.

At block 206, a number of tones to be used in distributed resource units may be determined.

At block 208, the distributed resource units may be allocated to the transmission.

At block 210, the transmission may be transmitted to the at least one station.

Modifications, additions, or omissions may be made to the method 200 without departing from the scope of the present disclosure. For example, the designations of different elements in the manner described is meant to help explain concepts described herein and is not limiting. Further, the method 200 may include any number of other elements or may be implemented within other systems or contexts than those described.

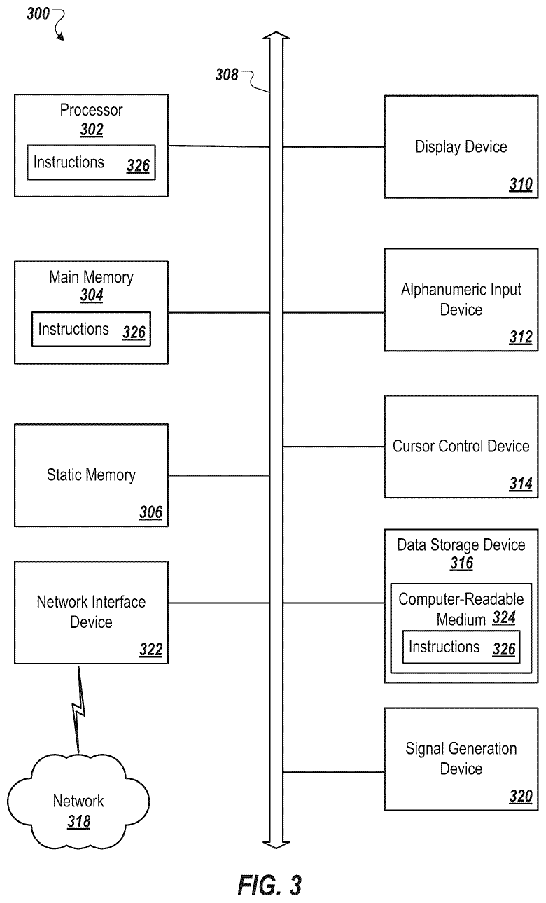

FIG. 3 illustrates an example computing device 300 within which a set of instructions, for causing the machine to perform any one or more of the methods discussed herein, may be executed. The computing device 300 may include a mobile phone, a smart phone, a netbook computer, a rackmount server, a router computer, a server computer, a personal computer, a mainframe computer, a laptop computer, a tablet computer, a desktop computer, or any computing device with at least one processor, etc., within which a set of instructions, for causing the machine to perform any one or more of the methods discussed herein, may be executed. In alternative implementations, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The computing device 300 includes a processing device 302 (e.g., a processor), a main memory 304 (e.g., read-only memory (ROM), flash memory, dynamic random access memory (DRAM) such as synchronous DRAM (SDRAM)), a static memory 306 (e.g., flash memory, static random access memory (SRAM)) and a data storage device 316, which communicate with each other via a bus 308.

The processing device 302 represents one or more general-purpose processing devices such as a microprocessor, central processing unit, or the like. More particularly, the processing device 302 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 302 may also include one or more special-purpose processing devices such as an application specific integrated circuit (ASIC), a field programmable gate array (FPGA), a digital signal processor (DSP), network processor, or the like. The processing device 302 is configured to execute instructions 326 for performing the operations and steps discussed herein.

The computing device 300 may further include a network interface device 322 which may communicate with a network 318. The computing device 300 also may include a display device 310 (e.g., a liquid crystal display (LCD) or a cathode ray tube (CRT)), an alphanumeric input device 312 (e.g., a keyboard), a cursor control device 314 (e.g., a mouse) and a signal generation device 320 (e.g., a speaker). In at least one implementation, the display device 310, the alphanumeric input device 312, and the cursor control device 314 may be combined into a single component or device (e.g., an LCD touch screen).

The data storage device 316 may include a computer-readable storage medium 324 on which is stored one or more sets of instructions 326 embodying any one or more of the methods or functions described herein. The instructions 326 may also reside, completely or at least partially, within the main memory 304 and/or within the processing device 302 during execution thereof by the computing device 300, the main memory 304 and the processing device 302 also constituting computer-readable media. The instructions may further be transmitted or received over a network 318 via the network interface device 322.

While the computer-readable storage medium 324 is shown in an example implementation to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although implementations of the present disclosure have been described in detail, various changes, substitutions, and alterations could be made hereto without departing from the spirit and scope of the present disclosure.

What is claimed is:

1. A system, comprising:
at least one station; and
a transmitter operable to transmit a transmission to the at least one station, the transmission being associated with a bandwidth, wherein:
the transmitter adaptively selects a modulation and coding scheme for the transmission;
the modulation and coding scheme allocates distributed resource units to the transmission; and
the distributed resource units are assigned to the at least one station and are distributed throughout the transmission.

2. The system of claim 1, further comprising a second station to receive a second transmission from the transmitter, wherein a second modulation and coding scheme is used for the second transmission and second distributed resource units are assigned to the second station and allocated to the second transmission.

3. The system of claim 1, wherein the distributed resource units are assigned to the at least one station based on factors associated with the system.

4. The system of claim 3, wherein the factors include one or more of a number of additional stations the at least one station is paired with, an additional bandwidth used by the additional stations, and a transmission method associated with the transmission.

5. The system of claim 4, wherein the transmission method is orthogonal frequency division multiple access.

6. The system of claim 1, wherein the modulation and coding scheme selected by the transmitter is adapted based on the transmission.

7. The system of claim 6, wherein the adaption is based on one or more of the transmission being a single user transmission to the at least one station, and the transmission including orthogonal frequency division multiple access packets at a subset of the bandwidth to the at least one station and a second transmission to a second station.

8. The system of claim 1, wherein the distributed resource units comprise are non-contiguous subcarriers.

9. The system of claim 1, wherein the distributed resource units provide a sample of a channel response associated with a channel over which the transmission is transmitted.

10. The system of claim 1, wherein the distributed resource units are selected based on a frequency associated with the bandwidth.

11. The system of claim 1, wherein one or more tones are removed from the distributed resource units.

12. The system of claim 11, wherein the one or more tones are removed to accommodate low density parity check.

13. A method, comprising:
obtaining data to be transmitted to at least one station;
adaptively selecting a modulation and coding scheme for the transmission;
determining a number of tones to be used in distributed resource units;
allocating the distributed resource units to the transmission; and
transmitting the transmission to the at least one station.

14. The method of claim 13, further comprising:
adaptively selecting a second modulation and coding scheme for a second transmission to a second station;
determining a second number of tones to be used in second distributed resource units;
allocating the second distributed resource units to the second transmission; and
transmitting the second transmission to the second station.

15. The method of claim 13, wherein the distributed resource units are assigned to the at least one station based on factors associated with the transmitter, the factors including one or more of a number of additional stations the at least one station is paired with, an additional bandwidth used by the additional stations, and a transmission method associated with the transmission.

16. The method of claim 15, wherein the transmission method is orthogonal frequency division multiple access.

17. The method of claim 13, wherein the modulation and coding scheme selected by the transmitter is adapted based on the transmission.

18. The method of claim 13, wherein the distributed resource units comprise are non-contiguous subcarriers.

19. The method of claim 13, wherein the distributed resource units provide a sample of a channel response associated with a channel over which the transmission is transmitted.

20. The method of claim 13, wherein one or more tones are removed from the distributed resource units and the one or more tones are removed to accommodate low density parity check.
